(19) United States
(12) Patent Application Publication
(10) Pub. No.: US 2005/0196042 A1
(43) Pub. Date: Sep. 8, 2005

(54) Method and apparatus for segmenting a microarray image

(76) Inventors: Jay S. Gehrig, Westford, MA (US); Hemantha D. Javali, Burlington, MA (US)

Correspondence Address: CESARI AND MCKENNA, LLP, 88 BLACK FALCON AVENUE, BOSTON, MA, 02210, US

(21) Appl. No.: 11/074,347

(22) Filed: Mar. 7, 2005

Related U.S. Application Data
(60) Provisional application No. 60/521,184, filed on Mar. 5, 2004.

(51) Int. Cl. G21K 1/00; G06K 9/34

(52) U.S. Cl. 382/175

(57) ABSTRACT

In a method for providing rapid and simple manually driven alignment of image segmentation grids to images of imperfect mircroarrays, an image of a microarray composed of multiple sub-arrays or blocks is displayed and a nominal grid composed of corresponding sub-arrays or blocks is superimposed on that image. Comer markers of a grid block are dragged to coincide with the spots at the corresponding corners of the underlying image block. The locations of the intervening grid markers in that block are automatically adjusted by linear interpolation in two dimensions. The corrections generated for this grid block are then applied automatically to all of the other blocks in the grid. Following this, the corner grid blocks are dragged to align a single corner marker within each corner grid block with an image spot at the corresponding corner block of the image, and all of the intervening grid blocks are automatically aligned to these by linear interpolation in two dimensions.

### CROSS-REFERENCE TO RELATED APPLICATION

The present application claims the benefit of U.S. Provisional Application Ser. No. 60/521184, filed on Mar. 5, 2005, which is hereby incorporated by reference herein.

### BACKGROUND OF THE INVENTION

This invention relates to microarrays. It relates more particularly to a method and apparatus for locating spots in a microarray image, also referred to as image segmentation.

A microarray is an array of very small samples of chemical or biochemical material drawn from reservoirs by a spotting instrument or spotter and deposited as a grid of many such spots on a solid substrate such as a glass microscope slide. When the microarray is exposed to selected probe material including a label molecule such as a fluorophore, the probe material selectively binds to the target sites only where complimentary binding spots are present through a process called hybridization thereby providing an assay. The microarray may then be scanned by a florescence-detecting scanning instrument or scanner to produce a pixel map of fluorescent intensities. To obtain statistically derived numerical data from the usually non-uniform and noisy fluorescent images of the spots, the scanning is done at high resolution so that each spot is represented by many pixels, e.g. up to 100 per spot. This fluorescent intensity map may be analyzed using special purpose quantitation algorithms which reveal the relative concentrations of the fluorescent probes and hence the level of gene expression, protein concentration, etc. present in the wells from which the assayed probe samples. This quantization step is usually performed on an image analysis computer or workstation and results in a set of numerical data which includes at least a numerical value of the representative probe signal for each microarray spot in the image.

The most common type of spotting instrument is the pin spotter which includes a plurality of printing pins arranged in a pattern on a robot-actuated print head. A typical print head may contain, say, sixteen pins arranged in a rectangular grid. The location tolerances between the print head and the printing tips of the individual pins is typically many tens of microns, which is larger than the typical robot's print head positioning tolerance of one to three microns. It is because of this and the necessity of avoiding the printing of merged or touching spots on the substrate that microarrays are usually printed as a pattern of sub-arrays or blocks, with one block being printed by each pin. The motion of the spotter's print head is such that each pin prints with a typical spot center-to-center distance within each block of 80 to 150 microns, whereas the spacing between adjacent blocks is typically 1.5 to 10 times larger than that.

This method is also applicable for use with multi-tip, non-contact piezo or ink-jet spotters. Instead of using pins, these instruments use one or more jets to form the spots on the microarray substrate.

The present invention concerns specifically the process of image segmentation or spot location in preparation for microarray quantitation. This is because the quantitation algorithm needs to know which pixels in the vicinity of each microarray spot are to be used to calculate that spot's intensity signal and which pixels, referred to as background pixels, should be excluded from that spot.

To start the spot location or segmentation process, the microarray image is usually displayed on an image analysis computer or workstation monitor. Then, an image of a grid of microarray spot location markers which usually reflect the diameter of the spots is superimposed on the image. This grid may be generated by the spotter and delivered to the work station via a file, e.g. the standard gal file promulgated by Axon Instruments Co., via a disk, bus or other data transfer means. Alternatively, the nominal grid information, e.g. number of rows and columns in the grid, the grid pattern, nominal spot spacing, etc. may be entered manually by a user via the workstation's keyboard.

A typical grid image may be a pattern of circles constituting the spot location markers with or without grid lines connecting the circles. Alternatively, crosses, polygons or other shapes can represent the markers in the grid image. The grid image is generally moveable on the microarray image by dragging and dropping it using a computer mouse, track ball or other computer pointing device. In some software implementations, individual spot location markers, or marker columns and rows can be repositioned with respect to the microarray image and the rest of the grid by dragging and dropping same.

In practice, a nominal grid rarely aligns well with the underlying scanned microarray image due to the combined effects of various tolerances in the spotting instrument. These include variations in the locations of the pin tips in the spotter's print head, misalignment of the print head with the spotter's x/y motion axes, non-orthogonality of the spotter's motion axes, spotter robot motion accuracy errors, and microarray substrate location errors in the spotter. There also may be scanning mechanism location accuracy errors in the scanner which scans the microarray image during the segmentation process.

Some of these errors are systematic in that they are repeatable for every microarray printed by a particular spotter, some errors are repeatable within a batch of printed arrays and some errors are random. For example, the shape of the outline of each microarray block is determined by the spotter robot's motion, the block size, the interspot distances and whether the block is rectangular or not. Since each block is printed simultaneously with all of the other blocks in the microarray, but with a different pin in the same print head, any deviations from the rectangular geometry within any block are usually identical in all of the other blocks. On the other hand, the location of the overall spot pattern in the image can vary from one array to another due to variations in the positions of the microarray substrates in the spotting instrument. A random spot location error may be caused by random variations in the motion of the print head in a given spotter which may cause small variations in the locations of individual spots within each block of the microarray.

Therefore, it is essential to reconcile the nominal location of each spot location marker in the nominal grid with the actual spot location in the underlying image. This has been done heretofore wholly manually, e.g. using a computer mouse, by moving or rotating a nominal grid of each block in the microarray or the whole array using visual feedback to align the spot location markers in the grid with the spots in the microarray image as displayed on the workstation monitor. For grid/array errors involving more than simple translations and/or rotations of the grid, a user may adjust the positions of individual spot location markers by dragging those markers and/or entire rows or columns of markers. This process is usually effective because the human eye is very sensitive to misalignment of similarly sized objects. However, if the blocks in the microarray image are not rectangular, but have other shapes such as a parallelogram or a trapezoid, such errors cannot be addressed by simply translating, rotating or scaling the nominal grid. In other words, the prior segmentation programs do not allow for changing the overall shape of the nominal grid to fit imperfect microarrays. Moreover, manual manipulation of individual markers or rows or columns of such markers within the grid association with a given microarray to locate the spots is a tedious and time consuming task, bearing in mind that a typical microarray may contain thousands of spots.

There do exist various algorithms which perform such spot location automatically see e.g. U.S. Pat. Nos. 6,349,144 and 6,345,115. Such automating of the spot location process eliminates the painstaking labor involved in the manual methods described above, but the algorithms that are available to do so can produce erroneous results, especially for dim or noisy microarray images, See Marzolf et al., Validation of Microarray Image Analysis Accuracy, Bio Techniques 36:304-308, February 2004. Such automatic spot location techniques are also more likely to fail with increased location errors between the nominal grid markers and the actual spot locations in the microarray image.

In any event, spot location errors, if not corrected before quantitation, can lead to mis-identified spots (analytes) in the analysis of the array or incorrect quantitation results for some spots. Because of these frequent spot location errors with automatic spot location apparatus, manual inspection and correction of the automatic spot location results must often be performed thereby undoing some of the labor saving steps intended through the use of such automatic spot location methods.

Therefore, what is needed is a method and apparatus for locating spots in a microarray image which provides the accuracy and reliability of the manual spot location technique described above thereby avoiding spot location errors, while doing away with the tedious and time consuming task of manually aligning the nominal grid or individual spot location markers or rows and columns of same on each microarray image.

### SUMMARY OF THE INVENTION

Accordingly the present invention aims to provide an improved apparatus for locating spots in a microarray image.

Another object of the invention is to provide such apparatus which allows rapid and simple manual alignment of nominal image segmentation grids to the images of imperfect microarrays.

A further object of the invention is to provide a spot location apparatus of this type which is user friendly and may be implemented in most microarray analysis workstations.

Yet another object of the invention is to provide a method for locating spots in a microarray image which allows rapid and simple manual alignment of nominal image segmentation grids to the images of imperfect microarrays.

Other objects will, in part, be obvious and will, in part, appear hereinafter.

The invention accordingly comprises the several steps and the relation of one or more of such steps with respect to each of the others, and the apparatus embodying the features of construction, combination of elements and arrangement of parts which are adapted to effect such steps, all is exemplified in the following detailed description, and the scope of the invention will be indicated in the claims.

Briefly, in accordance with the present method, a microarray image is segmented into discreet segments for each spot in the microarray by superimposing a segmentation grid and realigning that grid to the microarray image as has been done heretofore. However, instead of realigning the grid by moving individual spot location markers in the grid or individual rows and/or columns of same, two or more markers in the grid are manually aligned with corresponding spots in the underlying image and linear interpolation in two dimensions is employed between those manually aligned markers to align the remaining markers in the grid. This results in an actual reshaping and/or resizing of the grid to correspond to the imperfect shape of the underlying microarray image due to the systematic errors in the spotter which laid down that image.

Preferably, the method is first applied to a single block of the grid. This results in a realignment of that block with the corresponding block of the underlying image and a concomitant change in the geometry of that block which changes are automatically made in all of the other blocks in the grid. Then, the individual grid blocks are realigned to the corresponding blocks of the underlying microarray image using a similar two dimensional linear interpolation in a manner which does not change the already-modified internal geometry of the blocks.

Preferably, the manual alignment of a grid block or the entire grid is accomplished by aligning markers at or near the corners of a nominally rectangular grid composed of nominally rectangular blocks.

Once the nominal locations of the markers in the grid have been reconciled with the actual spot locations in the underlying image, the image is segmented into a plurality of spot and background components depending upon whether the pixels comprising each spot fall within or without the corresponding grid marker. Each spot is then quantitated to produce a value representing the brightness of that spot. A quantitation may be accomplished simply by calculating for each spot the mean, median or mode of the pixels inside the boundary of the corresponding spot marker as is well known in the art or it may be a more complex calculation such as one based on pixel value histograms.

Once the grid image has been reconfigured as aforesaid it may be saved and stored in a memory or on a disk or other data storage device. When analyzing a new image of another microarray produced by the same spotter operating in the same manner, that stored modified grid may be recalled and used as the nominal grid for the new image.

Since microarrays produced under the same conditions have very similar geometric errors, using a pre-modified nominal grid produced as aforesaid reduces or eliminates the amount of time required for subsequent image segmentation according to the present method. Indeed in many cases, no further alignment of the grid is needed, especially if the grid markers are smaller than the microarray spots. If the markers are larger than random spot location errors, the spot may be moved around a little inside the marker. In these cases, image segmentation can be much more reliable and as quick or even quicker than segmentation utilizing prior automatic spot-finding algorithms. In other cases, minor adjustments of spot location markers in the grid may still be required, but they can be accomplished very quickly and simply because by using the present method, all of the systematic errors have been accounted for in advance.

### BRIEF DESCRIPTION OF THE DRAWINGS

For a fuller understanding of the nature and objects of the invention, reference should be made to the following detailed description taken in connection with the accompanying drawings, in which:

FIG. 1 is diagrammatic view of a microarray image composed of a multiplicity of spots and with visible deviations from the ideal rectangular geometry of such an array;

FIG. 2 is a similar view showing a nominal rectangular grid superimposed on the FIG. 1 image;

FIG. 3 shows the steps for locating spots in the FIG. I image according to the invention;

FIG. 4 is a view similar to FIG. 2 but with the nominal grid repositioned so that the spot location marker at its upper left hand corner is centered on the spot at the upper left hand corner of the microarray;

FIGS. 5A to 5C are diagrammatic views showing the successive adjustments of the shape of a block in the nominal grid of FIG. 2 to accomplish the objectives of the invention;

FIGS. 6A to 6C show the repositionings of the microarray blocks to adjust the shape of the overall grid in FIG. 2 as required for segmentation of the FIG. 1 image, and

FIG. 7 is a block diagram showing apparatus for carrying out the present method.

### DETAILED DESCRIPTION OF AN ILLUSTRATIVE EMBODIMENT

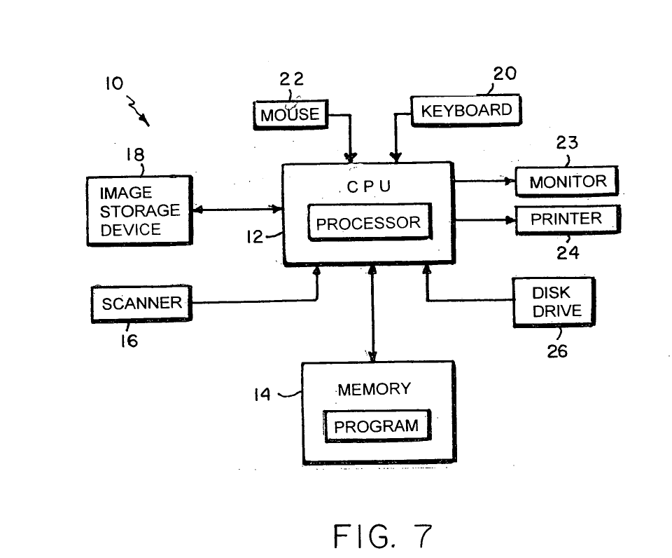

The present invention may be implemented as program instructions for configuring a microarray image analysis or quantitation workstation such as the one shown at 10 in FIG. 7. As shown there, workstation 10 may include a central processing unit (CPU) 12 which operates on program instructions in a memory 14 using a processor in CPU 12. A scanner 16 scans microarrays to obtain corresponding image data which may be stored in an image storage device 18 connected to CPU 12. A user may input instructions concerning the microarray image analysis by way of a keyboard 20 or a mouse 22 connected to CPU 12 and images and other data may be displayed on a monitor 23. Also, the workstation usually includes a printer 24 for printing images and data. Image data representing the nominal grid may be loaded into the workstation via a disk drive 26 and stored in memory 14 along with the program instructions for implementing the present invention.

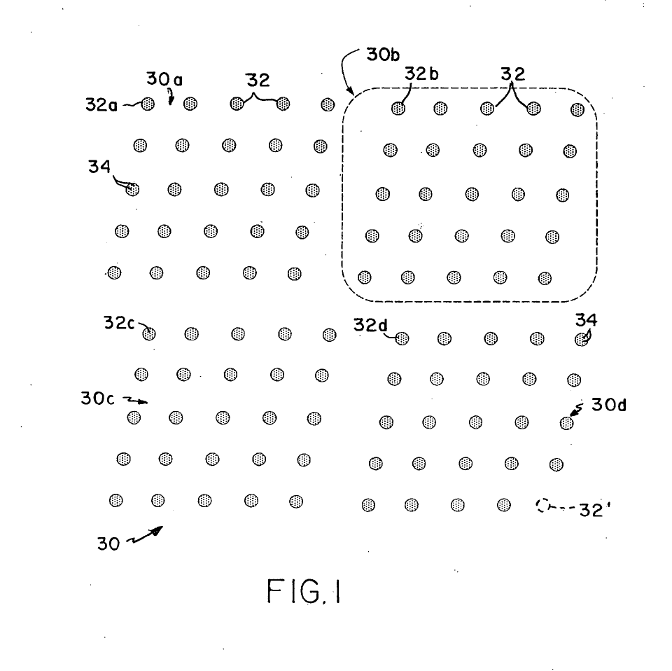

Refer now to FIG. 1 which illustrates an exemplary microarray image 30 which is composed of a plurality of substantially identical sub-arrays or blocks 30a to 30d located at the corners of array 30, each block including a plurality of spots 32. Array 30 is shown as containing only four blocks, each of which is a corner block and comprises twenty five spots 32. It should be understood, however, that a typical microarray may have as many as 48 or more blocks each of which may contain up to ten thousand spots 32. In other words, there may be many columns and rows of image blocks between the corner blocks 32a to 32d in the array 30 and many more spots 32 in each block.

While ideally the spots 32 in each array 30 are neatly arranged in columns and rows, in practice that is not the case. Rather, as discussed at the outset, the blocks 30a to 30d (and all the others) may be non-rectangular, e.g. parallelograms as shown in FIG. 1 because the X/Y motion axes of the print head in the spotter which laid down array 30 may not be orthogonal. Also, the blocks 30a to 30d may not be spaced evenly from one another because the pins in the spotter may be slightly bent. There may also be occasions when a spot 32 is missing from the array as indicated by the spot 32′ shown in phantom at the lower right hand corner of the lower right hand block 30d; this is a fairly common occurrence in microarray printing. However, the patterns of spots 32 in all of the blocks 30a to 30d are usually identical since the motion of the print head that locates each image block and each spot in a given block is identical for all of the pins in the print head, i.e. the errors are systematic.

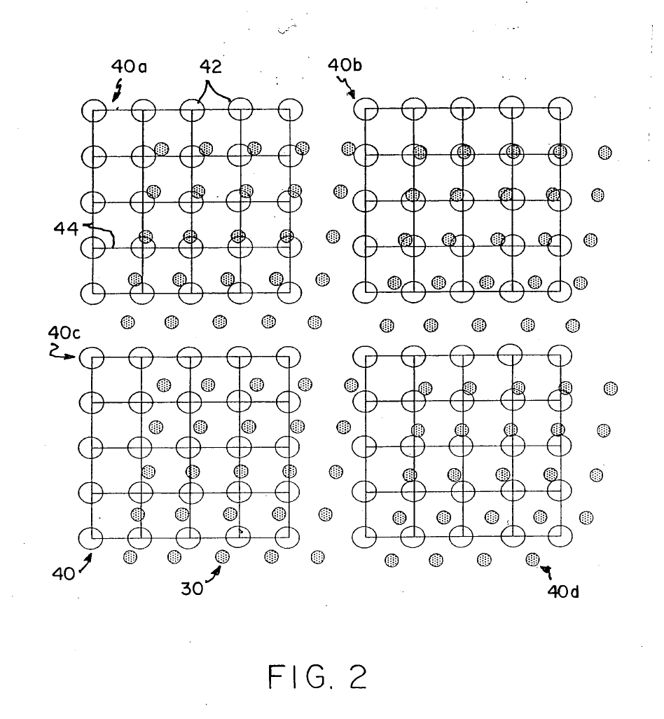

Refer now to FIG. 2 which shows the same image 30 illustrated in FIG. 1 with a nominal grid shown generally at 40 superimposed on that image 30. Grid 40 is composed of the same number of blocks as the number of image blocks present in underlying image 30, i.e., four blocks 40a to 40d. Each block 40a to 40d includes spot location markers 42 in the form of circles with intersecting grid lines 44 centered at each marker 42. While markers 42 as shown as circles, they could have a variety of other shapes such as crosses, squares, polygons, solid circles or blank areas in any type of grid image. Also, the grid lines 44 may or may not be displayed. In FIG. 2, the nominal grid image 40 is shown superimposed over image 30 at an arbitrary location that is not aligned with image 30. This is typical of the starting conditions for microarray image analysis or quantitation.

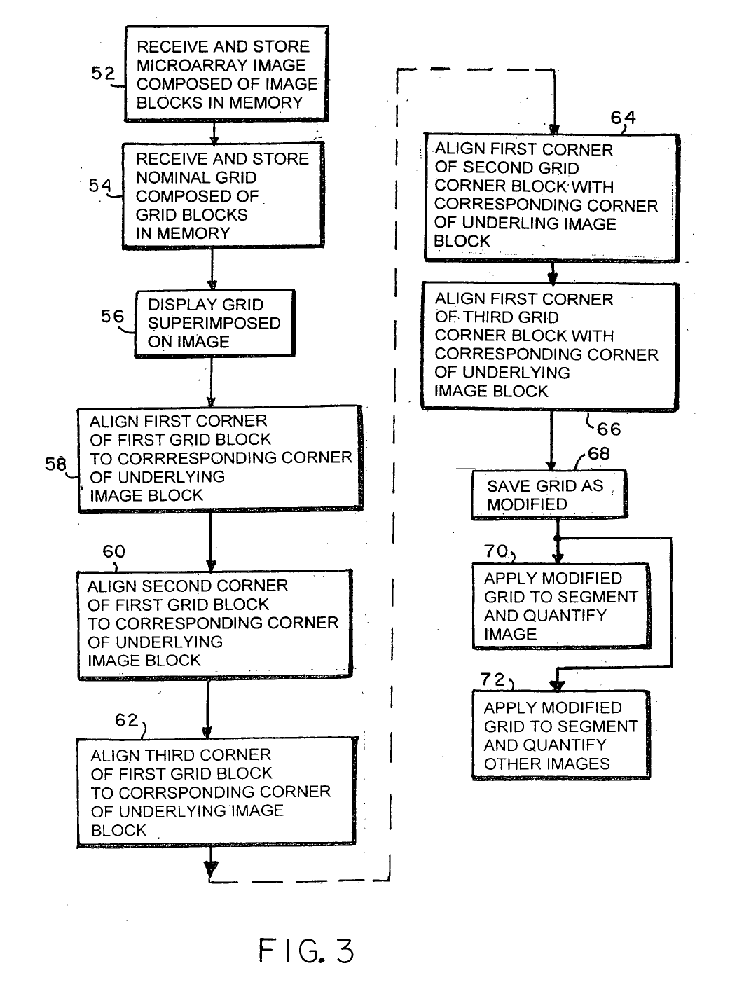

The microarray image 30 in FIG. 1 may be displayed on monitor 23 after the file for that image has been retrieved from storage device 18 and loaded into memory 14 in accordance with Step 52 in FIG. 3. On the other hand, the data for producing the grid image 40 may be stored on a disk and loaded into memory 14 by way of disk drive 26 so that the grid can be superimposed on the image 40 displayed on monitor 23 as indicated by Steps 54 and 56 in FIG. 3 and shown in FIG. 2.

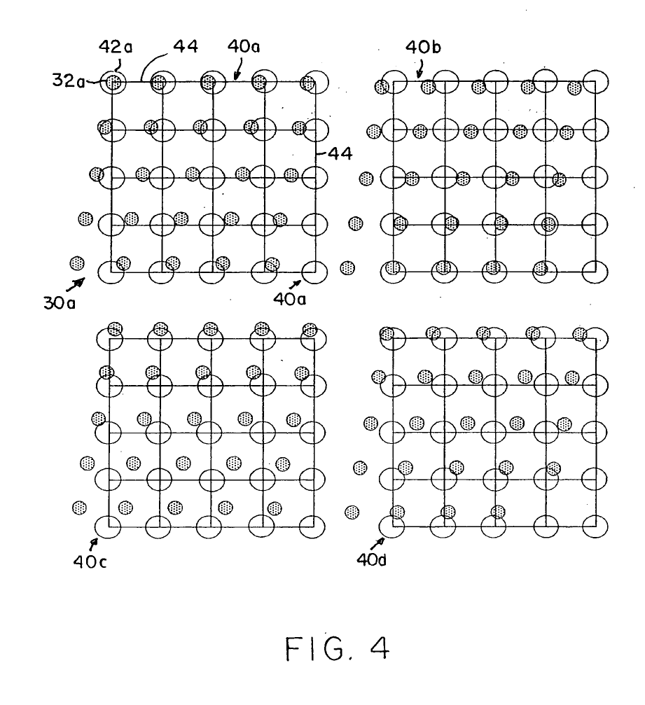

In accordance with the next step in the present method, i.e. Step 58, using mouse 22, the entire grid image 40 may be dragged relative to image 30 so that a marker 42a at or near a corner of grid image 40 is centered on the spot 32a at a corresponding corner of the underlying image 30 as shown in FIG. 4. In that display, the spot 32a and marker 42a happen to be at the upper left hand corner of the display. However, they could just as well be located at or near some other corner. In the event that the corner spot designated for grid alignment is missing from image 30; see 32′ in FIG. 1, the user may estimate the location where the missing spot would be and place the corresponding grid marker there.

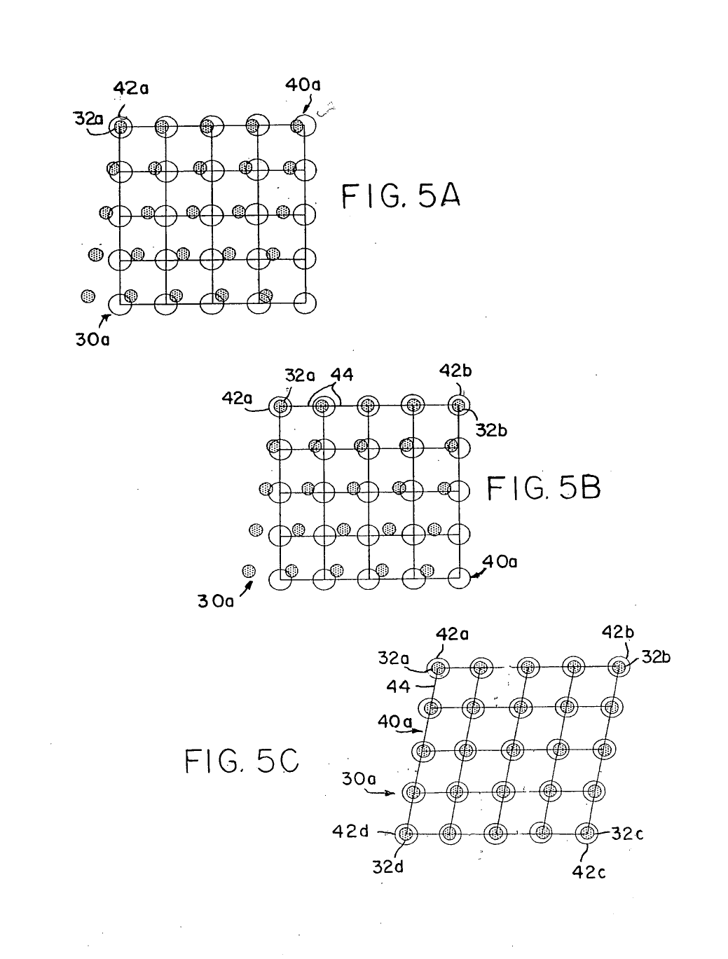

In any event, after Step 58 the overall grid 40 is generally not yet aligned sufficiently well with image 30 to allow accurate spot quantitation. Therefore, the next step in the method is to reconfigure the grid block containing the corner marker 42a that was aligned in the previous Step 58, i.e. block 40a shown in FIGS. 4 and 5A. For this, according to Step 60 in FIG. 3, a second marker 42b at or near another corner of the same grid block 40a, e.g. the upper right hand corner, is dragged using mouse 22 or otherwise positioned on the image spot 32b at the corresponding corner of the underlying image block 30a as shown in FIG. 5B. For the particular display shown there, the repositioning of grid marker 42b on the corresponding corner spot 32b involves only a horizontal stretching of the grid block 40a. If spot 32b had been located above or below its illustrated position, the repositioning of marker 42b would also involve a rotation of the grid block about the left hand corner marker 42a. In any event, the rectangular arrangement of the columns and rows of markers with the grid block 40a remains the same.

Normally the last grid block alignment step, i.e. Step 62 in FIG. 3, is to manually position a third spot location marker 42d at or near a third corner of the same grid block 40a, e.g. the lower right hand corner, on the corresponding spot 32c of the underlying image block 30a. In response, the computer program changes the overall shape of grid block 40a from a rectangle to a parallelogram to conform to the shape of the image block 30a by automatically moving the right hand boundary of grid block 40a so that it connects markers 42b and 42c. The other markers on that right hand boundary are moved automatically by linear interpolation so that they are equally spaced apart along that boundary. Likewise, the horizontal grid lines 44 terminated by those other markers are automatically repositioned. Any horizontal adjustment of the lower right hand corner marker 42d also automatically shifts the horizontal locations of the vertical grid lines by linear interpolation in much the same way so as to keep an equal spacing between them. Thus the program performs a linear interpolation in two dimensions simultaneously to reconfigure the grid to fit the underlying array block.

For a systematic error that produces a microarray image 30 whose blocks are shaped as a parallelogram as shown in FIG. 1, the reconfiguration of the grid 40a following the program in memory 14 as described in connection with FIGS. 5A-5C will automatically align the spot location marker 42c at lower left hand corner of block 40a with the corresponding corner spot 32c in the underlying image block 30a as shown in FIG. 5C. If, however, the image block 30a should have another shape, e.g. a trapezoid, it would be necessary to drag that marker 42d so that it is centered on the corresponding spot 32c in the underlying image block 30a. That is, for such an unexpected image shape all four corner markers 42a to 42d may have to be manually aligned with the corresponding four spots 32a-32d of the underlying image block 30a. This will automatically relocate all of the other markers in the grid block 42a with respect to the corresponding spots of the underlying image block 30a.

An algorithm for realigning the grid block 40a by dragging and dropping the corners of the grid block as described above may take different forms. One such algorithm constructs the grid lines 44 at the four boundaries of the nominal grid block 40a to connect the four corner markers 42a to 42d. These boundary lines 44 are automatically regenerated to reconnect those markers whenever those markers are moved by dragging. Also, the remaining markers along each of the grid lines 44 at those boundaries are automatically relocated along each boundary line by linear interpolation so they are equally spaced along that boundary line. The other vertical and horizontal grid lines 44 criss-crossing the grid block 40a in both dimensions are automatically reconstructed to connect the grid markers 44 at the boundaries with their corresponding opposites in both the nominal horizontal and vertical directions. Finally, the markers 42 of those crossing grid lines are automatically repositioned to the intersections of the relocated crossing grid lines 44.

In any event, after Step 62 in FIG. 3, the first grid block 40a has been fully reconfigured to fit its corresponding image block 30a and provides sufficient alignment of the spots in block 40a for reliable quantitation.

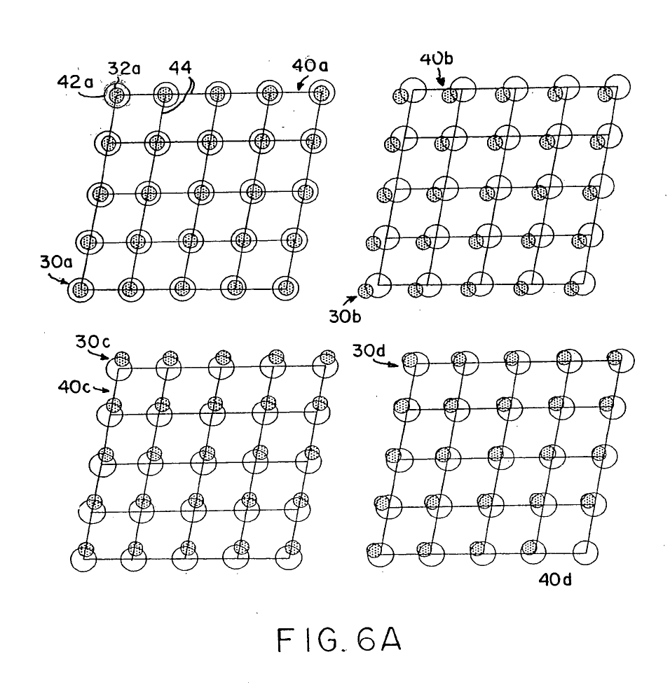

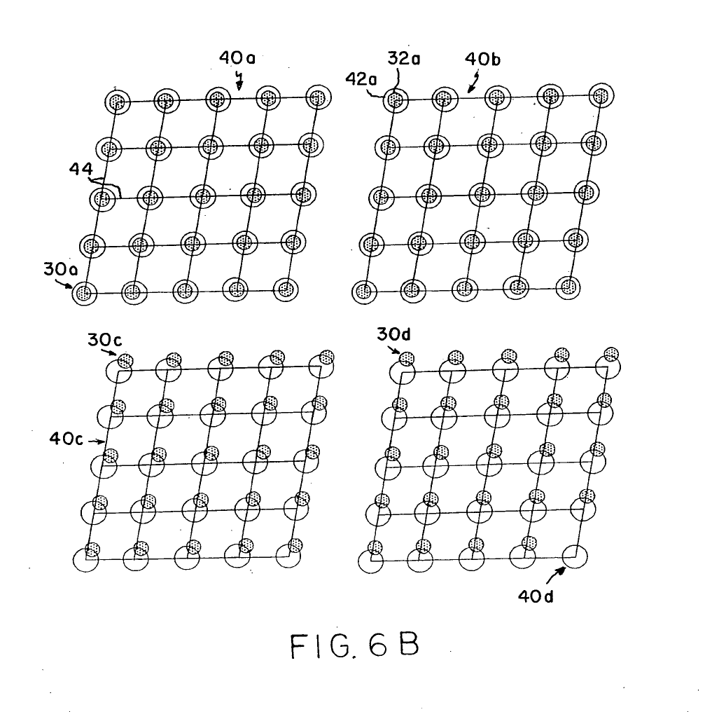

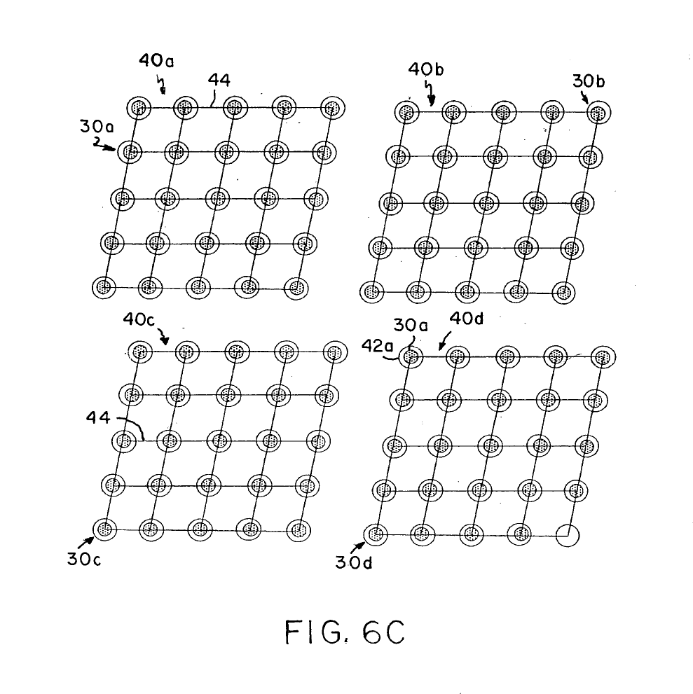

It should be understood that when the first grid block 40a is reconfigured as described above, the program in memory 14 automatically reconfigures all of the other grid blocks 40b-40d in the grid 40 in the same way as shown in FIG. 6a. This can be done because as noted above all of the image blocks are printed by the very same spotter print head, just with different pins in that head. Thus, the shapes of all of the image blocks in image 30 are highly likely to be almost identical for any conventional multi-tip microarray spotter or printer.

As shown in FIG. 6a, while all the grid blocks 40a-40d are appropriately shaped and the first block 40a is aligned with the corresponding image block 30a after following Steps 52 to 62 in FIG. 3, the other grid blocks 40b to 40d may still not be well aligned with their corresponding image blocks 30b to 30d. Thus in accordance with the present method, the location of each additional grid block 40b-40d within the overall grid pattern is now adjusted in more or less the same way used to reshape the first grid block 40a.

Thus, the relocation of the grid blocks 40b-40d relative to block 40a within the overall grid 40 is accomplished by manual alignment of a marker in at least two of those corner blocks with corresponding spots in underlying image blocks at or near other corners of the image 30. More particularly, after grid block 40a is aligned with the underlying image block 30a as shown in FIGS. 5C and 6A, the upper left hand marker 42a of a grid block at a second corner of grid image 40, e.g. the upper right hand block 40b, is positioned on the corresponding spot 32a of the underlying image block 30b by dragging the entire grid block 40b using mouse 22 as directed by Step 64 in FIG. 3. Just as in the case of the grid block 40a, as this is done, the horizontal spacings of all of the grid blocks in the grid image 40 are adjusted by linear interpolation. The final alignment of grid image 40 with image 30 is accomplished by Step 66 wherein the marker 42a at the upper left hand corner of a third grid corner block, i.e. block 40d, is aligned with the corresponding spot 32a of the underlying image block 30d by dragging the entire grid block 40d using mouse 22 as shown in FIG. 6C. Usually, the relocation of the three corner blocks of grid 40a as aforesaid automatically repositions the remaining corner block 40c with the underlying image block 30c as shown in that figure. However, if necessary, as described for the grid block 40a, the lower left hand grid block 40c may be repositioned by dragging that block so that the marker 42a at the upper left hand corner of block 40c is centered on the spot 32a at the corresponding corner of the image block 30c. tional grid blocks may be located between blocks 40a-40d in both the vertical and horizontal directions. When the corner blocks are relocated as described above, the locations of any other blocks in the grid are automatically relocated by linear interpolation in two dimensions along lines extending between the corner blocks 40a-40d. In other words, any other grid blocks are automatically repositioned by situating their upper left hand corner markers 40a on the quadrilateral defined by the lines connecting the markers 42a of the four corner blocks 40a-40d. That is, those grid blocks at the boundaries of grid 40 are spaced evenly along the quadrilateral and those blocks inboard of that boundary are spaced evenly along vertical and horizontal lines 44 connecting the markers 40a of the grid blocks at the boundary lines of the overall grid image 40.

After the grid image 40 has been modified as described above and stored in memory 14, Step 68, the values of the microarray spots may be quantified in the usual way by calculating the mean, median or mode of the spot pixels within markers 42 or by a more complex calculation based on pixel histograms, Step 70. That image as modified may also be stored on a disk or other medium for later retrieval when analyzing other microarrays laid down by the same spotter operating under the same conditions as indicated by Step 72 in FIG. 3.

Image segmentation performed as described above can be accomplished quickly and reliably to account for most systematic errors due to imperfections in the spotting instrument. In the event that the grid requires additional minor adjustments, these can be taken care of quite easily since the major systematic errors have already been addressed.

It will thus be seen that the objects set forth above, among those made apparent from the preceding description, are efficiently attained. Also, certain changes may be made in carrying out the above method and in the construction set forth without departing from the scope of the invention. For example, the grid image 40 is shown as containing four blocks to simplify the explanation of the invention. However the software for implementing this method may allow for a single grid block, e.g. block 40a, to be used as a template to electronically reposition the blocks of data corresponding to the other corner blocks in image 40 by dragging and dropping that template in accordance with Steps 64 and 66. Therefore, it is intended that all matter contained in the above description or shown in the accompanying drawings shall be interpreted as illustrative and not in a limiting sense.

It is also to be understood that the following claims are intended to cover all of the generic and specific features of the invention described herein.

1. A method of segmenting an electronic image of an imperfect microarray composed of a pattern of spots into spot segments, said method comprising the steps of
displaying said image on a display device;
superimposing a generally rectangular grid of nominal spot locations on said image, said grid being composed of an array of spot location markers, said markers corresponding to nominal locations of the spots in said image and the size of the markers being approximately equal to the nominal diameter of the spots;
geometrically adjusting said grid by dragging the grid to align a marker at or near a first corner of the grid with the image spot at the corresponding corner of the underlying image;
effecting one or more subsequent geometric adjustments of the grid by dragging a marker at or near one or more other corners of the grid to positions in alignment with corresponding spots in the underlying image, and
automatically adjusting the positions of all other markers in the grid by linear interpolation in two dimensions simultaneously so as to produce a geometrically modified grid image.

2. The method of claim 1 including the additional steps of
forming the microarray so that said image constitutes one block of a larger image composed of other similar blocks, and
automatically applying said adjustment steps to said other similar blocks simultaneously.

3. The method of claim 1 including the additional step of quantifying said segments by calculating signal values therefor.

4. The method of claim 3 wherein each of said spots is composed of pixels, and said quantifying is accomplished by
applying a histogram to the pixels in each of said spot segments;
eliminating high-value outlier pixels, and/or low-value outlier pixels from the calculation of the signal values, and
calculating the signal values as one of the mean, medium or mode of the remaining pixels in the spot segments.

5. The method of claim 1 including the additional step of storing said modified grid image.

6. The method of any one of claims 1 to 5 including using said modified grid image to segment an electronic image of a microarray into spot and background segments.

7. The method of claim 6 including the additional steps of saving said modified grid image as a computer-readable record or file, and
retrieving the saved modified grid image via an image analysis computer for use in subsequent image quantitation.

8. The method of claim 7 including the additional step of using said retrieved modified grid image directly for segmentation on one or more other microarray images without any additional grid adjustment.

9. The method of claim 7 including the additional step of using said retrieved modified grid as the starting point for a manual grid adjustment on a different microarray image.

10. The method of claim 7 including the additional step of using said retrieved modified grid as the starting point for automatic spot location on a different microarray image.

11. Apparatus for segmenting microarray image data into spot segments, said apparatus comprising:
means for displaying an electronic image of a microarray;
a geometrically deformable grid image superimposed on the microarray image with a visible alignment marker corresponding to each nominal spot in the microarray;
pointing means for manipulating objects on said displaying means, said pointing means for use in aligning a first marker with a first spot in the microarray by dragging said grid image and aligning other markers in the grid image by dragging each of said other markers individually, and
means for reshaping said grid by linear interpolation in two dimensions between said first and other markers.

12. The system of claim 11 wherein said deformable grid image is loaded from a computer readable record or file.

13. The system of claim 1 1 wherein said deformable grid image derives from a microarray spotting instrument.

14. The system of claim 11 wherein said deformable grid image is the output or result of a pervious grid image alignment process.

15. A computer-readable storage medium having stored therein a program which segments an electronic microarray image into spot segments by executing the steps of
displaying said image on a display device;
superimposing a generally rectangular grid of nominal spot locations on said image, said grid being composed of an array of spot location markers, said markers corresponding to nominal locations of the spots in said image and the size of the marker being approximately equal to the nominal diameter of the spots;
geometrically adjusting said grid by dragging the grid to align a marker at or near a first corner of the grid with the image spot at the corresponding corner of the underlying image;
effecting one or more subsequent geometric adjustments of the grid by dragging a marker at or near one or more other corners of the grid to positions in alignment with corresponding spots in the underlying image, and
automatically adjusting the positions of all other markers in the grid by linear interpolation in two dimensions simultaneously so as to produce a geometrically modified grid image.
